(19) United States
(12) Patent Application Publication
(10) Pub. No.: US 2026/0179980 A1
(43) Pub. Date: Jun. 25, 2026

(54) GAS-LIQUID SEPARATION HUMIDIFIER

(71) Applicants: Hyundai Motor Company, Seoul (KR); Kia Corporation, Seoul (KR)

(72) Inventors: Ju Yong Lee, Hwaseong-Si (KR); Jin Hun Lee, Hwaseong-Si (KR); Seong Yun Hwang, Hwaseong-Si (KR); Hyun Yoo Kim, Hwaseong-Si (KR); Ho Kyo Jung, Hwaseong-Si (KR)

(21) Appl. No.: 19/256,465

(22) Filed: Jul. 1, 2025

(30) Foreign Application Priority Data
Dec. 19, 2024 (KR) 10-2024-0191701

(51) Int. Cl. H01M 8/04119; H01M 8/04492; H01M 8/04746

(52) U.S. Cl. CPC H01M 8/04164; H01M 8/04149; H01M 8/04492; H01M 8/04761

(57) ABSTRACT

The present disclosure provides a gas-liquid separation humidifier. The gas-liquid separation humidifier includes a housing that includes: a humidification membrane provided in a humidification chamber formed inside the housing; an inlet port connected to a gas inflow chamber formed inside the housing; and a discharge port connected to a gas discharge chamber formed inside the housing. The gas-liquid separation humidifier may be configured to: collect moisture, separated from an exhaust gas that is discharged from a fuel cell stack and enters the housing through the inlet port, in a moisture collection chamber formed inside the housing; and discharge the collected moisture out of the housing.

### CROSS-REFERENCE TO RELATED APPLICATION

This application claims priority to Korean Patent Application No. 10-2024-0191701, filed in the Korean Intellectual Property Office on Dec. 19, 2024, the entire contents of which are incorporated herein by reference.

### TECHNICAL FIELD

The present disclosure relates to a fuel cell system, and more particularly to a gas-liquid separation humidifier of a fuel cell system.

### BACKGROUND

A fuel cell system may produce electrical energy by means of a chemical reaction of supplied fuel, such as hydrogen and oxygen. research and development on fuel cell technology are continuing as it is considered an important component in solving global environmental issues.

Based on the types of electrolytes used for the fuel cell system, the fuel cell system may be classified as a phosphoric acid fuel cell (PAFC), a molten carbonate fuel cell (MCFC), a solid oxide fuel cell (SOFC), a polymer electrolyte membrane fuel cell (PEMFC), an alkaline fuel cell (AFC), a direct methanol fuel cell (DMFC), or the like. Depending on the required operating temperatures, output ranges, and the like, as well as the types of fuels being used, different types of fuel cell systems may be used in various applications such as mobile power, transportation, distributed power generation, and the like.

Among the different types of fuel cells, the polymer electrolyte membrane fuel cell may be applied to hydrogen vehicles (e.g., hydrogen fuel cell vehicles), which are touted potential successors to internal combustion engine vehicles.

A hydrogen electric vehicle may produce electricity by means of a chemical reaction between hydrogen and oxygen and use the generated electricity to drive the motor of the vehicle. More specifically, the hydrogen electric vehicle may include a hydrogen tank for storing hydrogen (H₂), a fuel cell stack for producing electricity by means of an oxidation-reduction reaction between hydrogen and oxygen (O₂), a battery for storing the electricity produced by the fuel cell stack, a controller for converting and control the produced electricity, and a motor for generating the driving power of the vehicle.

As byproducts of a fuel cell reaction, air may be exhausted, water vapor may also be discharged, as water droplets, as part of a gas discharged from a cathode of the fuel cell. If the droplets are introduced into a turbine, the impact of the droplets on the turbine wheel may affect the turbine wheel, which may be rotating at a high speed.

Therefore, proper management or restriction of the number of droplets being introduced into the turbine wheel is crucial to a successful implementation of a turbine-integrated air compressor in a fuel cell system.

The matters described in this Background section are only for enhancement of understanding of the background of the disclosure, and should not be taken as acknowledgment that they correspond to prior art already known to those skilled in the art.

### SUMMARY

The present disclosure has been made in an effort to provide a gas-liquid separation humidifier that may protect a turbine wheel by ensuring gas-liquid separation performance by changing a structure of a humidifier, suppress degradation of a humidification membrane, reduce the number of droplets remaining in the humidifier, prevent the droplets from accumulating in the humidifier, and prevent a large number of droplets from being supplied to a turbine in a transitional section.

According to one or more example embodiments of the present disclosure, a gas-liquid separation humidifier may include a housing. The housing may include: a humidification membrane provided in a humidification chamber formed inside the housing; an inlet port connected to a gas inflow chamber formed inside the housing; and a discharge port connected to a gas discharge chamber formed inside the housing. The gas-liquid separation humidifier may be configured to: collect moisture, separated from an exhaust gas that is discharged from a fuel cell stack and enters the housing through the inlet port, in a moisture collection chamber formed inside the housing; and discharge the collected moisture out of the housing.

The moisture collection chamber may be a gas-liquid separator configured to separate a gas from a liquid and prevent droplets from forming on the humidification membrane.

The gas-liquid separator may include a wall disposed in the housing and below the inlet port. The wall may be configured to divert a flow of the exhaust gas.

The wall may be one of: in contact with the inlet port, or on a bottom surface of the housing and at a predetermined distance away from the inlet port.

The wall may be disposed to be perpendicular to or inclined with respect to a horizontal inner surface of the housing.

The wall may include a mesh having a plurality of pores formed on a plated surface.

The gas-liquid separator may include an upper moisture barrier that is plate-shaped and disposed below the discharge port formed on a horizontal inner surface of the housing. The upper moisture barrier may be configured to prevent the moisture contained in the exhaust gas from being discharged out of the housing.

The upper moisture barrier may contact a lower side of the discharge port and be disposed to be perpendicular to or inclined with respect to the horizontal inner surface of the housing.

A gas-liquid separation chamber may be formed on a bottom surface of the housing and disposed below the discharge port. The gas-liquid separation chamber may connect to the humidification chamber and be configured to collect the moisture separated from the exhaust gas.

A lower moisture barrier may be provided at an upper side of the gas-liquid separation chamber and be configured to seal the upper side of the gas-liquid separation chamber to reduce scattering of the collected moisture in the gas-liquid separation chamber.

The lower moisture barrier may include: a first partition wall disposed in a width direction of the gas-liquid separation chamber; and a second partition wall disposed in a height direction of the gas-liquid separation chamber.

The first partition wall may be disposed in a horizontal direction or inclined downward toward an end of the gas-liquid separation chamber.

The second partition wall may be disposed in a vertical direction or inclined upward toward a wall surface of the gas-liquid separation chamber.

The gas-liquid separation humidifier may further include: a second discharge port disposed on a lower portion of the gas-liquid separation chamber; and a discharge valve installed in the second discharge port. The discharge valve may be configured to selectively discharge the collected moisture out of the housing through the second discharge port.

The gas-liquid separation humidifier may further include a level sensor installed at one side of the gas-liquid separation chamber and configured to measure an amount of the collected moisture. The discharge valve may be further configured to open or close based on the measured amount of the collected moisture.

At least one bypass hole may be provided on the bottom surface of the housing and formed through a partition plate, which separates the gas inflow chamber from the gas discharge chamber, so that the collected moisture contained in the exhaust gas flows along the bottom surface of the housing and is discharged to the gas-liquid separation chamber.

The at least one bypass hole may include a plurality of bypass holes formed at a plurality of points along a width direction of the partition plate.

An auxiliary gas-liquid separation chamber may be formed below the inlet port and provided on the bottom surface of the housing. The auxiliary gas-liquid separation chamber may connect to the humidification chamber and is configured to collect the moisture separated from the exhaust gas. A flow channel may connect the auxiliary gas-liquid separation chamber to the gas-liquid separation chamber.

According to one or more example embodiments of the present disclosure, a gas-liquid separation humidifier may include a housing. The housing may include: a humidification membrane provided in a humidification chamber formed inside the housing; an inlet port connected to a gas inflow chamber formed inside the housing; and a discharge port connected to a gas discharge chamber formed inside the housing. The gas-liquid separation humidifier may be configured to: collect moisture, separated from an exhaust gas that enters the housing through the inlet port, in a moisture collection chamber formed inside the housing; and discharge the collected moisture out of the housing. The moisture collection chamber may be a gas-liquid separator configured to separate a gas from a liquid and prevent droplets from forming on the humidification membrane.

### BRIEF DESCRIPTION OF THE DRAWINGS

FIG. 1 is a top plan view illustrating a structure of an example gas-liquid separation humidifier.

FIG. 2 is a top plan view illustrating a structure of an example gas-liquid separation humidifier.

FIG. 3 is a top plan view illustrating a structure of an example gas-liquid separation humidifier.

FIG. 4 is a top plan view illustrating a structure of an example gas-liquid separation humidifier.

FIG. 5 is a top plan view illustrating a structure of an example gas-liquid separation humidifier.

FIG. 6 is a top plan view illustrating a structure of an example gas-liquid separation humidifier.

FIG. 7 is a top plan view illustrating a structure of an example gas-liquid separation humidifier.

FIG. 8 is a top plan view illustrating a structure of an example gas-liquid separation humidifier.

FIG. 9 is a top plan view illustrating a structure of an example gas-liquid separation humidifier.

FIG. 10 is a top plan view illustrating a structure of an example gas-liquid separation humidifier.

### DETAILED DESCRIPTION

Hereinafter, a gas-liquid separation humidifier according to one or more example embodiments of the present disclosure will be described with reference to the accompanying drawings.

However, the technical spirit of the present disclosure is not limited to some embodiments described herein but may be implemented in various different forms. One or more of the constituent elements in the example embodiments may be selectively combined and substituted for use within the scope of the technical spirit of the present disclosure.

In addition, unless otherwise specifically and explicitly defined and stated, the terms (including technical and scientific terms) used in the example embodiments of the present disclosure may be construed as the meaning which may be commonly understood by the person with ordinary skill in the art to which the present disclosure pertains. The meanings of the commonly used terms such as the terms defined in dictionaries may be interpreted in consideration of the contextual meanings of the related technology.

In addition, the terms used in the example embodiments of the present disclosure are for explaining the embodiments, not for limiting the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

In addition, the terms such as first, second, A, B, (a), and (b) may be used to describe constituent elements of the example embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

At least in some implementations, a method of protecting the turbine wheel from droplets may use a gas-liquid separator provided at a front end of the turbine. In order to use the gas-liquid separator, enough space needs to be set aside to mount the gas-liquid separator. As a result, a problem may arise in terms of the restrictiveness of packaging of the related components while ensuring efficiency of the gas-liquid separator, such as a vertical gas-liquid separator or a horizontal gas-liquid separator.

Further, another problem may be the added weight and cost of the entire system due to the extra weight and cost of the gas-liquid separator, hoses, and other materials that are needed to connect the gas-liquid separator to the other components.

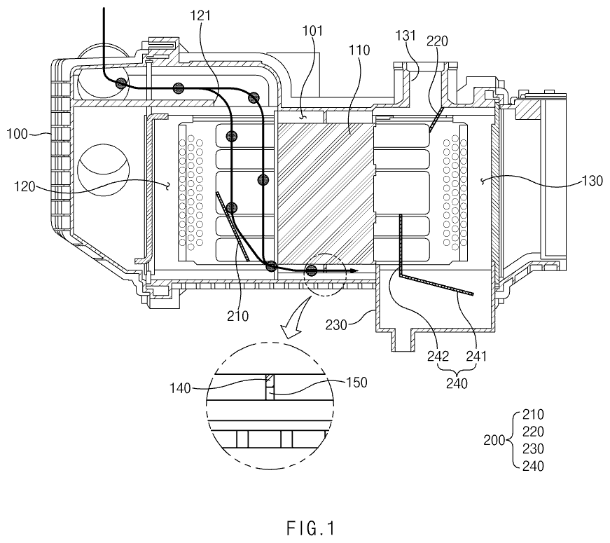

FIGS. 1 through 10 are top plan views showing a structure of an example gas-liquid separation humidifier. The various components and configurations as shown in these figures are combinable.

As illustrated in these drawings, the gas-liquid separation humidifier may include a housing 100 having therein a humidification space (also referred to as a humidification chamber) 101 in which a humidification membrane 110 is disposed. The housing 100 may have an inflow space (also referred to as a gas inflow chamber or a gas intake chamber) 120 provided with an inlet port 121, and a discharge space (also referred to as a gas discharge chamber) 130 provided with a discharge port 131. A chamber (also referred to as a moisture collection chamber) may be installed in the housing 100 and configured to collect droplets (e.g., water droplets or moisture) contained in an exhaust gas and discharged from a fuel cell stack and introduced through the inlet port 121, and discharge the droplets outside the housing 100.

The chamber may include a gas-liquid separator (also referred to as a gas-liquid separation part) 200 configured to separate a liquid from a gas while preventing the droplets from coming into contact with (e.g., contact) the humidification membrane 110 (e.g., preventing droplets from forming on the humidification membrane 110).

The humidification space 101 is provided in the housing 100. The humidification space 101 may be divided (e.g., separated) by a partition plate (also referred to as a partition or a partition wall) 140 into the inflow space 120, through which the exhaust gas discharged from the fuel cell stack is introduced, and the discharge space 130 through which the exhaust gas introduced may be discharged.

The humidification membrane 110 may be provided in the housing 100. The humidification membrane 110 may allow dry air to flow across (e.g., while coming into contact with) an inner surface of the humidification membrane 110 and allow humid air to flow across (e.g., while coming into contact with) an outer surface of the humidification membrane 110, such that moisture in the humid air may be transmitted to (e.g., exchanged with) the dry air, and the dry air may be humidified.

The inlet port 121, which may serve as a passageway through which the exhaust gas is introduced, may be formed at one side of the inflow space 120 and may be open (e.g., allowing intake air to flow in). The discharge port 131, which may serve as a passageway through which the exhaust gas is discharged, may be formed at one side of the discharge space 130 and may be open (e.g., allowing exhaust air to flow out).

The gas-liquid separator 200 may be installed in the housing 100 and separate droplets (e.g., water droplets or moisture) contained in the exhaust gas introduced into the housing 100. The gas-liquid separator 200 may ensure that, when the exhaust gas is discharged outside through the discharge port 131, the exhaust gas is free of droplets.

Because the droplets (e.g., water droplets or moisture) are removed from the exhaust gas, damage to a turbine wheel may be alleviated or prevented even when the exhaust gas, which is discharged after passing through the housing 100 of the gas-liquid separation humidifier, is introduced into a turbine that rotates at a high speed.

The gas-liquid separator 200 may include a droplet guide (also referred to as a diverter, a wall, a diverting wall, a gutter, a pipe, a tube, a conduit, or a flow channel) 210 provided in the housing 100, disposed below the inlet port 121, and configured to guide (e.g., divert) the flow of a liquid and/or a gas, such as an exhaust gas (e.g., an exhaust gas from a fuel cell stack). The droplet guide 210 may divert the flow of the liquid and/or the gas, for example, in a predetermined direction based on the orientation of the droplet guide 210. The droplet guide 210 may be configured as a single droplet guide 210 or a plurality of droplet guides 210. The droplet guide 210 may be made of metal, plastic, rubber, or the like. A plurality of pores may be formed on a plated surface of the droplet guide 210, or no pore may be formed on the plated surface of the droplet guide 210.

However, if the droplet guide 210 is formed in a mesh shape having a plurality of pores formed on a plated surface thereof, the pores may have small diameters (e.g., smaller than a threshold width) to the extent that only humid air may pass through the pores, but the droplets (e.g., water droplets or moisture) cannot pass through the pores, such that deterioration in humidification performance may be minimized.

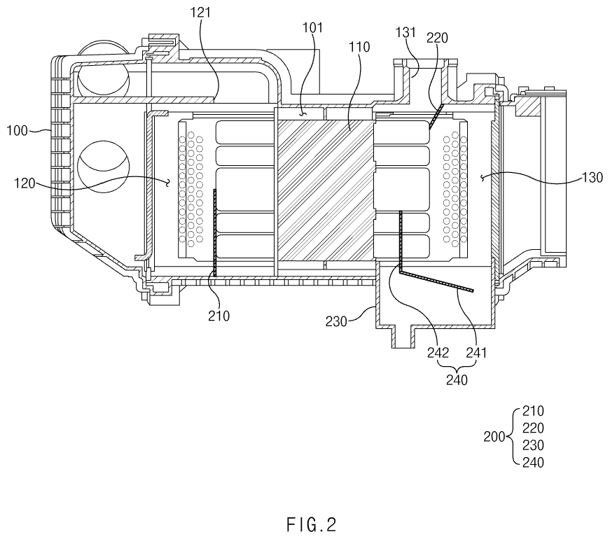

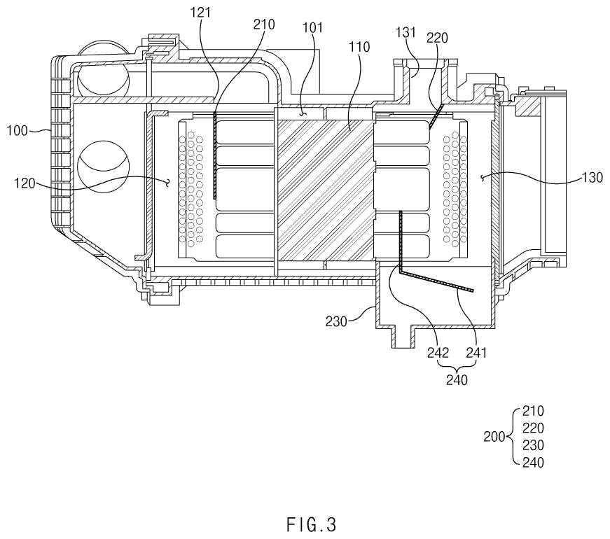

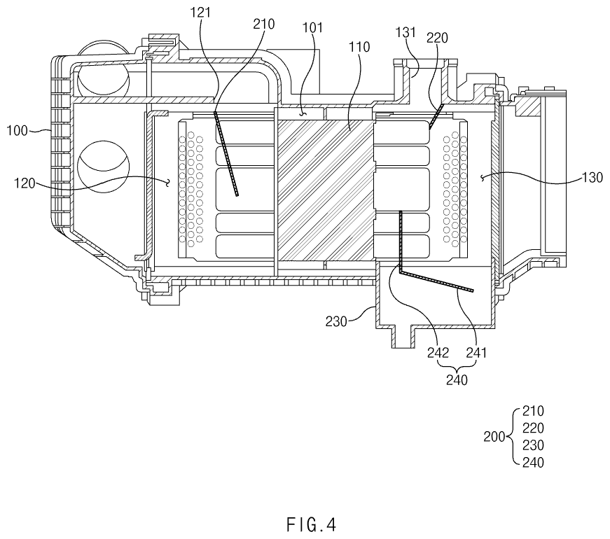

As illustrated in FIGS. 1 and 2, the droplet guide 210 may be installed on a bottom surface of the housing 100 spaced apart (e.g., separated) from the inlet port 121 at a predetermined interval (e.g., distance). As illustrated in FIGS. 3 and 4, the droplet guide 210 may be installed below the inlet port 121 and provided to be in contact with the inlet port 121.

As illustrated in FIGS. 1 and 2, in case that the droplet guide 210 is installed on the bottom surface of the housing 100 spaced apart (e.g., separated) from the inlet port 121 at a predetermined interval (e.g., distance), the exhaust gas, which is introduced into (e.g., enters) the humidification space 101 of the housing 100 through the inlet port 121, may quickly flow to the discharge space 131.

As illustrated in FIGS. 3 and 4, in case that the droplet guide 210 is installed below the inlet port 121 and provided to be in contact with the inlet port 121, the exhaust gas introduced through the inlet port 121 may be prevented from being diffused (e.g., spread) in the inflow space 121, and the exhaust gas may quickly flow to the discharge space 131 along the droplet guide 210.

The droplet guide 210 may be disposed to be perpendicular to or inclined with respect to an inner surface of the housing 100 formed in a horizontal direction (e.g., with respect to a horizontal surface of the housing 100). In case that the droplet guide 210 is disposed to be inclined, the angle of incline may vary depending on the size of the humidifier, and a length of the droplet guide 210 may vary depending on the size of the humidifier.

To reduce or minimize deterioration in humidification performance of the humidifier, the droplet guide 210 may be installed in the housing 100 such that an end (e.g., tip) of the droplet guide 210 does not enter a window side.

The gas-liquid separator 200 may include a plate-shaped upper-end droplet blocking partition wall (also referred to as a moisture barrier) 220 disposed below the discharge port 131 in the housing 100 formed in the horizontal direction (e.g., formed on a horizontal inner wall of the housing 100). The upper-end droplet blocking partition wall 220 may be configured to prevent the droplets (e.g., water droplets or moisture) contained in the exhaust gas from being discharged outside (e.g., outside the housing 100).

The upper-end droplet blocking partition wall 220 may be provided to be in contact with a lower side of the discharge port 131 and disposed to be perpendicular to or inclined with respect to the inner surface of the housing 100 formed horizontally. An angle at which the upper-end droplet blocking partition wall 220 is disposed to be inclined may vary depending on the size of the humidifier, and a length of the upper-end droplet blocking partition wall 220 may also vary depending on the size of the humidifier. The upper-end droplet blocking partition wall 220 may be provided as a single upper-end droplet blocking partition wall 220 or a plurality of upper-end droplet blocking partition walls 220.

The end of the upper-end droplet blocking partition wall 220 needs to be configured so as not to enter the window side. The upper-end droplet blocking partition wall 220 may be made of metal, plastic, rubber, or the like. The upper-end droplet blocking partition wall 220 may have pores or have no pores. However, in case that the pores are formed, it may be effective that the pores have small diameters (e.g., less than a threshold width) to the extent that only humid air may pass through the pores, but the droplets (e.g., water droplets or moisture) cannot pass through the pores, such that deterioration in efficiency in recovering energy from the turbine may be minimized.

A gas-liquid separation chamber 230 may be formed in the bottom surface of the housing 100 and disposed below the discharge port 131, and the gas-liquid separation chamber 230 may connect to the humidification space 101 of the housing 100. The gas-liquid separation chamber 230 may be a moisture collection chamber as described herein. The gas-liquid separation chamber 230 may collect the separated droplets (e.g., water droplets or moisture). The gas-liquid separation chamber 230 may be open at an upper side thereof and connect to the discharge space 130.

A lower-end droplet blocking partition wall 240 may be provided at an upper side of the gas-liquid separation chamber 230 and block (e.g., seal) the upper side of the gas-liquid separation chamber 230 from the outside in order to prevent the droplets (e.g., water droplets or moisture) collected in the gas-liquid separation chamber 230 from scattering (e.g., reduce scattering of the droplets).

The lower-end droplet blocking partition wall 240 may include a first partition wall 241 disposed in a width (e.g., lateral or horizontal) direction of the gas-liquid separation chamber 230, and a second partition wall 242 disposed in a height (e.g., vertical) direction of the gas-liquid separation chamber 230.

The first partition wall 241 may be disposed in the horizontal direction or disposed to be inclined downward toward the inside of the gas-liquid separation chamber 230 toward an end thereof. The second partition wall 242 may be disposed in the vertical direction or disposed to be inclined upward so that the second partition wall 242 becomes close to a wall surface of the gas-liquid separation chamber 230.

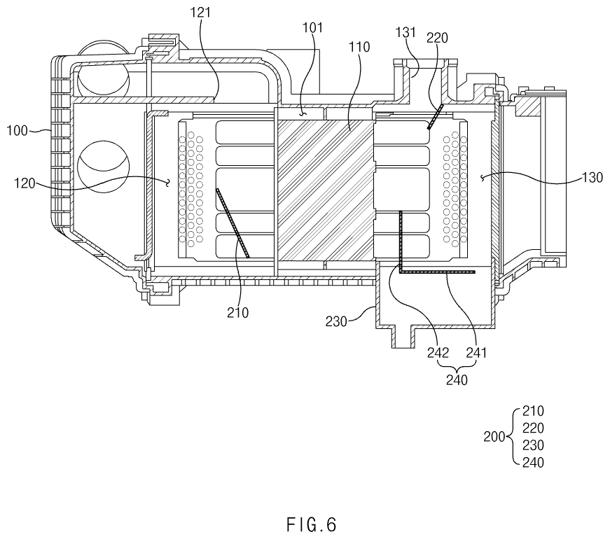

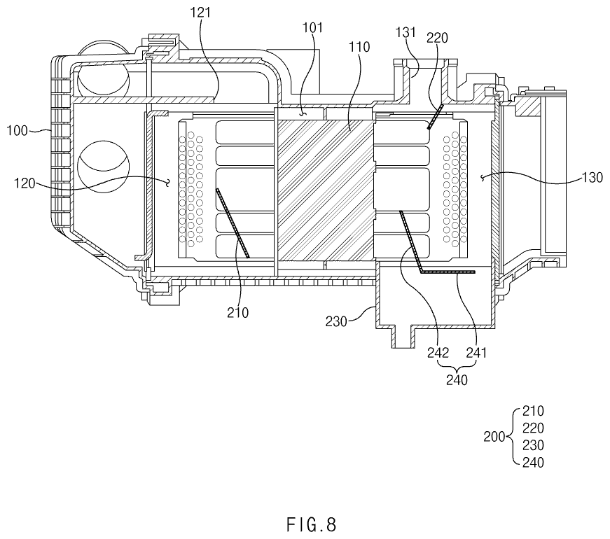

As illustrated in FIGS. 6 and 8, in case that the first partition wall 241 is disposed in the horizontal direction, a large number of droplets (e.g., water droplets or moisture) may be collected in the gas-liquid separation chamber 230, and an area of the upper side of the gas-liquid separation chamber 230 blocked (e.g., sealed) by the first partition wall 241 may be maximized, such that the scattering of the droplets may be maximally prevented.

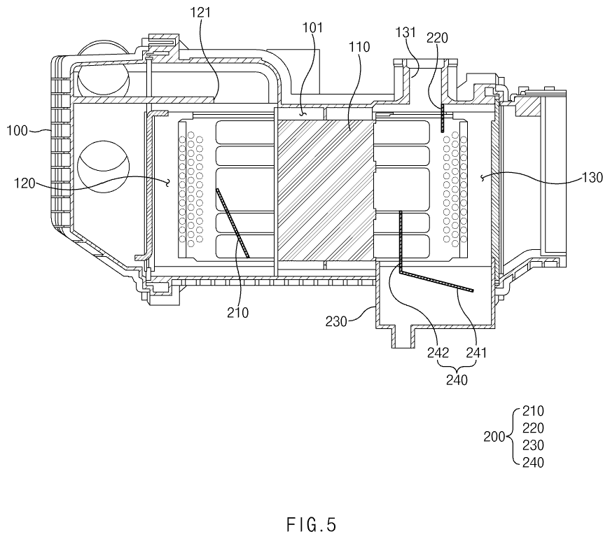

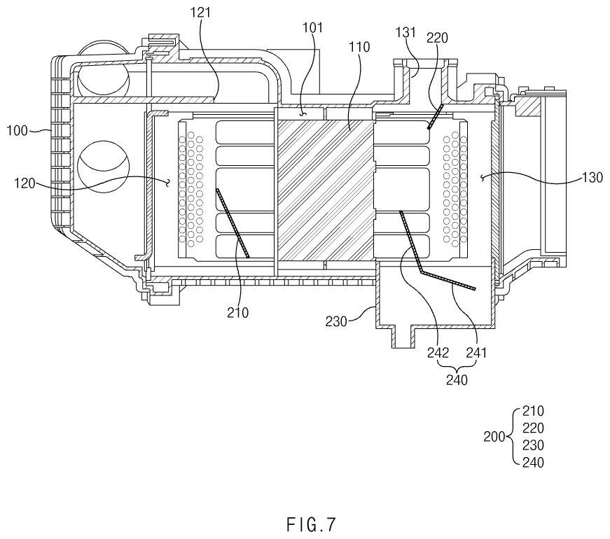

As illustrated in FIGS. 5 and 7, in case that the first partition wall 241 is disposed to be inclined downward toward the inside of the gas-liquid separation chamber 230 toward the end thereof, even the droplets (e.g., water droplets or moisture) forming on an upper surface of the first partition wall 241 may be collected in the gas-liquid separation chamber 230, such that the efficiency in collecting droplets may be improved.

As with the upper-end droplet blocking partition wall 220, the end of the lower-end droplet blocking partition wall 240 may also need to be configured so as not to enter the window side. The lower-end droplet blocking partition wall 240 may be made of metal, plastic, rubber, or the like. The lower-end droplet blocking partition wall 240 may have a shape having pores or a shape having no pores. However, in case that the pores are formed, it is effective that the pores have small diameters to the extent that only humid air may pass through the pores, but the droplets (e.g., water droplets or moisture) cannot pass through the pores, such that deterioration in efficiency in recovering energy from the turbine may be minimized.

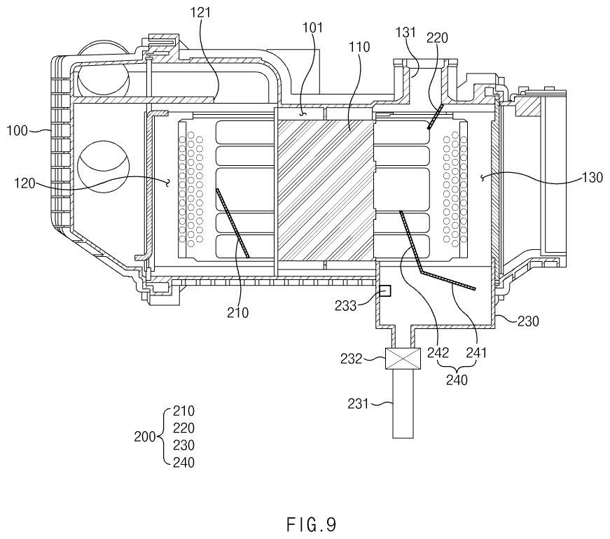

As illustrated in FIG. 9, a discharge port (also referred to as a lower discharge port) 231, through which the collected droplets (e.g., water droplets or moisture) may be discharged outside, may be formed on a lower portion of the gas-liquid separation chamber 230. A discharge valve 232 may be installed in the discharge port 231 so that the collected droplets may be selectively discharged.

The discharge port 231 may extend by a predetermined length from the lower portion (e.g., bottom) of the gas-liquid separation chamber 230. In case that a large number (e.g., amount) of droplets (e.g., water droplets) are collected in the gas-liquid separation chamber 230, the droplets may be discharged outside, such that the droplets may be consistently collected. The discharge valve 232 provided in the discharge port 231 does not discharge the droplets until the droplets reach a predetermined level in the gas-liquid separation chamber 230.

To determine whether to open or close the discharge valve 232, a level sensor 233 is installed at one side of the gas-liquid separation chamber 230 to measure a level of the collected droplets.

A bypass hole 150 may be formed in the bottom surface of the housing 100 and formed through the partition plate 140. The partition plate 140 may separate the inflow space 120 from the discharge space 130, so that the droplets (e.g., water droplets or moisture content) contained in the exhaust gas introduced through the inlet port 121 may flow along the bottom surface of the housing and then be discharged to the gas-liquid separation chamber 230.

The bypass hole 150 may be provided as a plurality of bypass holes 150 formed at a plurality of points in a width direction of the partition plate 140. In case that the droplets (e.g., water droplets or moisture) move to a bottom side of the inflow space 120, the bypass hole 150 serves to move the droplets to the gas-liquid separation chamber 230 so that the droplets may be discharged immediately outside.

The bottom surface of the housing 100 may be formed smoothly without a stepped portion so that the droplets (e.g., water droplets or moisture) may quickly move to the gas-liquid separation chamber 230 through the bypass hole 150.

Not only the droplets (e.g., water droplets or moisture) but also the air in the housing 100 may flow through the bypass hole 150, which may affect the humidification performance. The position of the window, the number of windows, and the area of the window may be adjusted to prevent deterioration in humidification performance.

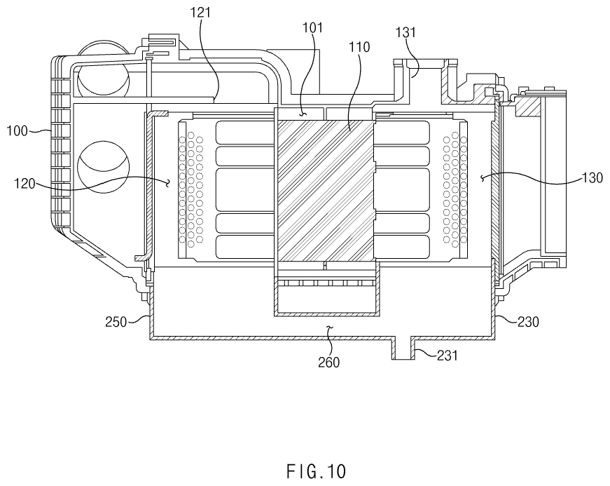

As illustrated in FIG. 10, an auxiliary gas-liquid separation chamber 250 may be disposed below the inlet port 121 and provided in the bottom surface of the housing 100. The auxiliary gas-liquid separation chamber 250 may be a moisture collection chamber as described herein. The auxiliary gas-liquid separation chamber 250 may connect to the humidification space 101 of the housing 100 and collect the separated droplets (e.g., water droplets or moisture). A separate bypass member (also referred to as a passage, a flow passage, a channel, a flow channel, a tube, a tunnel, a conduit, etc.) 260 may be disposed between the auxiliary gas-liquid separation chamber 250 and the gas-liquid separation chamber 230 and connect the auxiliary gas-liquid separation chamber 250 to the gas-liquid separation chamber 230.

The bypass member 260 may allow the auxiliary gas-liquid separation chamber 250 and the gas-liquid separation chamber 230 to connect to each other in a flat state in which there is no stepped portion between a bottom surface of the gas-liquid separation chamber 230 and a bottom surface of the auxiliary gas-liquid separation chamber 250, such that the droplets (e.g., water droplets or moisture) collected in the auxiliary gas-liquid separation chamber 250 may be smoothly and effectively introduced into the gas-liquid separation chamber 230.

As necessary, the other side of the bypass member 260 connected to the gas-liquid separation chamber 230 is disposed to be lower than one side of the bypass member 260 connected to the auxiliary gas-liquid separation chamber 250, such that the droplets (e.g., water droplets or moisture) collected in the auxiliary gas-liquid separation chamber 250 may be quickly introduced into the gas-liquid separation chamber 230.

In order to achieve the above-mentioned object, the present disclosure provides a gas-liquid separation humidifier including: a housing having therein a humidification space in which a humidification membrane is provided, the housing having an inflow space provided with an inlet port, and a discharge space provided with a discharge port; and a gas-liquid separation part installed in the housing and configured to prevent droplets, which are contained in an exhaust gas discharged from a fuel cell stack and introduced through the inlet port, from coming into contact with the humidification membrane and discharge the droplets to the outside.

In this case, the gas-liquid separation part may include a droplet guide provided in the housing, disposed below the inlet port, and configured to guide a flow of the exhaust gas.

Further, the droplet guide may be installed below the inlet port and provided to be in contact with the inlet port, or the droplet guide may be installed on a bottom surface of the housing spaced apart from the inlet port at a predetermined interval.

In addition, the droplet guide may be disposed to be perpendicular to or inclined with respect to an inner surface of the housing formed in a horizontal direction.

Further, the droplet guide may be provided in a mesh shape having a plurality of pores formed in a plate surface thereof.

Further, the gas-liquid separation part may include a plate-shaped upper-end droplet blocking partition wall disposed below the discharge port in the housing formed in a horizontal direction, the upper-end droplet blocking partition wall being configured to prevent the droplets contained in the exhaust gas from being discharged to the outside.

In addition, the upper-end droplet blocking partition wall may be in contact with a lower side of the discharge port and disposed to be perpendicular to or inclined with respect to an inner surface of the housing formed horizontally.

Further, a gas-liquid separation chamber may be formed in a bottom surface of the housing and disposed below the discharge port, and the gas-liquid separation chamber may communicate with the humidification space of the housing and collect the separated droplets.

Further, a lower-end droplet blocking partition wall may be provided at an upper side of the gas-liquid separation chamber and block the upper side of the gas-liquid separation chamber from the outside in order to prevent the droplets collected in the gas-liquid separation chamber from scattering.

In addition, the lower-end droplet blocking partition wall may include: a first partition wall disposed in a width direction of the gas-liquid separation chamber; and a second partition wall disposed in a height direction of the gas-liquid separation chamber.

Further, the first partition wall may be disposed in a horizontal direction or disposed to be inclined downward toward the inside of the gas-liquid separation chamber toward an end thereof.

Further, the second partition wall may be disposed in a vertical direction or disposed to be inclined upward so that the second partition wall becomes close to a wall surface of the gas-liquid separation chamber.

In addition, a discharge port, through which the collected droplets are discharged to the outside, may be formed on a lower portion of the gas-liquid separation chamber, and a discharge valve may be installed in the discharge port so that the collected droplets are selectively discharged.

Further, a separate level sensor may be installed at one side of the gas-liquid separation chamber and measure a level of the collected droplets in order to determine whether to open or close the discharge valve.

Further, a bypass hole may be provided in the bottom surface of the housing and formed through a partition plate, which separates the inflow space and the discharge space, so that the droplets contained in the exhaust gas introduced through the inlet port flow along the bottom surface of the housing and are discharged to the gas-liquid separation chamber.

In addition, the bypass hole may be provided as a plurality of bypass holes formed in a width direction of the partition plate.

As described above, the gas-liquid separation humidifier according to the present disclosure may protect the turbine wheel by ensuring gas-liquid separation performance by changing the structure of the humidifier, suppress degradation of the humidification membrane, reduce the number of droplets remaining in the humidifier, prevent the droplets from accumulating in the humidifier, and prevent a large number of droplets from being supplied to the turbine in the transitional section.

The gas-liquid separation humidifier according to the present disclosure configured as described above may protect the turbine wheel by ensuring gas-liquid separation performance by changing the structure of the humidifier, suppress degradation of the humidification membrane, reduce the number of droplets remaining in the humidifier, prevent the droplets from accumulating in the humidifier, and prevent a large number of droplets from being supplied to the turbine in the transitional section.

While the example embodiments, which may be implemented by the present disclosure, have been described above, the embodiments are just illustrative and not intended to limit the present disclosure. It can be appreciated by those skilled in the art that various modifications and applications, which are not described above, may be made to the present embodiment without departing from the intrinsic features of the present disclosure. For example, the respective constituent elements specifically described in the example embodiments may be modified and then carried out. Further, it should be interpreted that the differences related to the modifications and applications are included in the scope of the present disclosure defined by the appended claims.

What is claimed is:

1. A gas-liquid separation humidifier comprising:
a housing comprising:
a humidification membrane provided in a humidification chamber formed inside the housing;
an inlet port connected to a gas inflow chamber formed inside the housing; and
a discharge port connected to a gas discharge chamber formed inside the housing,
wherein the gas-liquid separation humidifier is configured to:
collect moisture, separated from an exhaust gas that is discharged from a fuel cell stack and enters the housing through the inlet port, in a moisture collection chamber formed inside the housing; and
discharge the collected moisture out of the housing.

2. The gas-liquid separation humidifier of claim 1, wherein the moisture collection chamber is a gas-liquid separator configured to separate a gas from a liquid and prevent droplets from forming on the humidification membrane.

3. The gas-liquid separation humidifier of claim 2, wherein the gas-liquid separator comprises a wall disposed in the housing and below the inlet port, wherein the wall is configured to divert a flow of the exhaust gas.

4. The gas-liquid separation humidifier of claim 3, wherein the wall is one of:
in contact with the inlet port, or
on a bottom surface of the housing and at a predetermined distance away from the inlet port.

5. The gas-liquid separation humidifier of claim 3, wherein the wall is disposed to be perpendicular to or inclined with respect to a horizontal inner surface of the housing.

6. The gas-liquid separation humidifier of claim 3, wherein the wall comprises a mesh having a plurality of pores formed on a plated surface.

7. The gas-liquid separation humidifier of claim 2, wherein the gas-liquid separator comprises an upper moisture barrier that is plate-shaped and disposed below the discharge port formed on a horizontal inner surface of the housing, the upper moisture barrier being configured to prevent the moisture contained in the exhaust gas from being discharged out of the housing.

8. The gas-liquid separation humidifier of claim 7, wherein the upper moisture barrier contacts a lower side of the discharge port and be disposed to be perpendicular to or inclined with respect to the horizontal inner surface of the housing.

9. The gas-liquid separation humidifier of claim 2, wherein a gas-liquid separation chamber is formed on a bottom surface of the housing and disposed below the discharge port, and wherein the gas-liquid separation chamber connects to the humidification chamber and is configured to collect the moisture separated from the exhaust gas.

10. The gas-liquid separation humidifier of claim 9, wherein a lower moisture barrier is provided at an upper side of the gas-liquid separation chamber and is configured to seal the upper side of the gas-liquid separation chamber to reduce scattering of the collected moisture in the gas-liquid separation chamber.

11. The gas-liquid separation humidifier of claim 10, wherein the lower moisture barrier comprises:
a first partition wall disposed in a width direction of the gas-liquid separation chamber; and
a second partition wall disposed in a height direction of the gas-liquid separation chamber.

12. The gas-liquid separation humidifier of claim 11, wherein the first partition wall is disposed in a horizontal direction or inclined downward toward an end of the gas-liquid separation chamber.

13. The gas-liquid separation humidifier of claim 11, wherein the second partition wall is disposed in a vertical direction or inclined upward toward a wall surface of the gas-liquid separation chamber.

14. The gas-liquid separation humidifier of claim 9, further comprising:
a second discharge port disposed on a lower portion of the gas-liquid separation chamber; and
a discharge valve installed in the second discharge port, wherein the discharge valve is configured to selectively discharge the collected moisture out of the housing through the second discharge port.

15. The gas-liquid separation humidifier of claim 14, further comprising a level sensor installed at one side of the gas-liquid separation chamber and configured to measure an amount of the collected moisture, and wherein the discharge valve is further configured to open or close based on the measured amount of the collected moisture.

16. The gas-liquid separation humidifier of claim 9, wherein at least one bypass hole is provided on the bottom surface of the housing and formed through a partition plate, which separates the gas inflow chamber from the gas discharge chamber, so that the collected moisture contained in the exhaust gas flows along the bottom surface of the housing and is discharged to the gas-liquid separation chamber.

17. The gas-liquid separation humidifier of claim 16, wherein the at least one bypass hole comprises a plurality of bypass holes formed at a plurality of points along a width direction of the partition plate.

18. The gas-liquid separation humidifier of claim 16, wherein an auxiliary gas-liquid separation chamber is formed below the inlet port and provided on the bottom surface of the housing,
wherein the auxiliary gas-liquid separation chamber connects to the humidification chamber and is configured to collect the moisture separated from the exhaust gas, and
wherein a flow channel connects the auxiliary gas-liquid separation chamber to the gas-liquid separation chamber.

19. A gas-liquid separation humidifier comprising:
a housing comprising:
a humidification membrane provided in a humidification chamber formed inside the housing;
an inlet port connected to a gas inflow chamber formed inside the housing; and
a discharge port connected to a gas discharge chamber formed inside the housing,
wherein the gas-liquid separation humidifier is configured to:
collect moisture, separated from an exhaust gas that enters the housing through the inlet port, in a moisture collection chamber formed inside the housing; and
discharge the collected moisture out of the housing, and
wherein the moisture collection chamber is a gas-liquid separator configured to separate a gas from a liquid and prevent droplets from forming on the humidification membrane.
